(19) United States
(12) Patent Application Publication
(10) Pub. No.: US 2024/0046257 A1
(43) Pub. Date: Feb. 8, 2024

(54) METHOD FOR CONFIGURING A PAYMENT TERMINAL AND RELATED PAYMENT TERMINAL

(71) Applicant: BANKS AND ACQUIRERS INTERNATIONAL HOLDING, Suresnes (FR)

(72) Inventor: Francis BERTHIER, Saint Jean de Muzols (FR)

(73) Assignee: BANKS AND ACQUIRERS INTERNATIONAL HOLDING, Suresnes (FR)

(21) Appl. No.: 18/254,914

(22) PCT Filed: Nov. 24, 2021
(86) PCT No.: PCT/EP2021/082868

§ 371 Date: May 30, 2023

(30) Foreign Application Priority Data
Dec. 1, 2020 (FR) 20/12499

(51) Int. Cl. G06Q 20/38

(52) U.S. Cl. CPC G06Q 20/38215

(57) ABSTRACT

A method for configuring a payment terminal. The method includes a step of loading, within a secure memory of the payment terminal, a firmware comprising a plurality of distinct cryptographic methods, each cryptographic method of the plurality being intended to allow the subsequent implementation, by a third party having the cryptographic material adapted to the considered method, of operations for verifying the authenticity and the integrity of at least one application installed on the payment terminal.

### TECHNICAL FIELD

The field of the invention is that of electronic devices used for the implementation of software applications which involve or relate to objects of a confidential nature, and which are required as such to respect certain security requirements defined in particular within the context of standards or certifications. Among these devices, the invention relates more particularly to payment terminals.

### PRIOR ART

The payment terminals, used to carry out payment transactions, are specifically designed, both in terms of hardware and software, to offer the most optimal possible protection of the confidential data which are likely be entered or stored therein. In order to guarantee a sufficient level of security for these terminals, standards have been created, and certification procedures aimed at establishing the compliance of such devices with these standards have been developed. The use of payment terminals is thus subject to strict, mandatory and imposed security regulations. More particularly, these terminals must be certified in accordance with the PCI standards (for “Payment Card Industry”), such as for example with the PCI-PTS standard (for “Payment Card Industry-PIN Transaction Security”). These standards define security requirements both on the physical design of the hardware and on the software part implemented within these terminals. For example, sensitive data must generally be encrypted, and their processing is subject to cryptographic protocols. The use of software components capable of being implemented only within secure processors, inaccessible to third parties, is also generally required.

The PCI-PTS standard notably requires the deployment of means allowing verifying the authenticity and the integrity of the payment applications installed and executed on these terminals. As regards the payment terminal, these means generally take the form of a single cryptographic method (for example a specific method based on the RSA cryptographic system), specific to the manufacturer of the terminal, which is implemented within a firmware loaded in the factory into a secure memory of the terminal. The firmware integrating the cryptographic method must first have successfully passed a certification process guaranteeing its compliance with the security requirements required by the standard.

The subsequent use of the particular cryptographic method embedded in the certified firmware equipping a fleet of payment terminals—with the aim of carrying out operations of verifying the authenticity and the integrity of the payment applications installed therein—also requires the deployment, at customers purchasing these terminals, of a set of dedicated tools. These tools, which more particularly comprise cryptographic material specifically adapted to the implementation of the cryptographic method implemented in the acquired payment terminals (for example signature tools), represent generally a costly investment for the customer. Also, some customers are sometimes reluctant to acquire new terminals based on a cryptographic method different from the one they usually use to verify the authenticity and the integrity of the payment applications installed in their existing pool of payment terminals, with regard to significant costs to provide to acquire new tools compatible with the cryptographic method used in these new terminals. This reluctance can act as a brake on the adoption of new terminals offered by a manufacturer, and close markets therefor, in particular when this manufacturer markets ranges of payment terminals that are not all based on the same cryptographic method (which frequently happens for multiple reasons, for example during takeovers of competitors or mergers between manufacturers, or further due to innovations allowing the development of ranges of payment terminals incorporating ever more secure encryption techniques, etc.).

To address this issue, the solution generally adopted by the manufacturers consists of offering, for each range (or model) of payment terminals marketed, as many firmware as cryptographic methods likely to be offered to customers. Such a solution is however not without constraints for the manufacturer. In particular, it requires him to maintain, for each range of terminals, several branches of production in the factory, in order to be able to integrate, at the request of an acquiring customer, the specific firmware comprising the cryptographic method that is appropriate and compatible with the verification tools already deployed at this customer. In addition, this solution obliges the manufacturer to multiply the certification processes in order to guarantee that the numerous firmwares maintained are indeed all in conformity with the PCI standards in force, such processes which often prove to be long and difficult. All of these constraints have direct impacts for the manufacturer, leading in particular to an increase in the complexity and in the manufacturing cost of the payment terminals.

There is therefore a need to propose solutions aimed at overcoming at least some of these drawbacks of the prior art. More particularly, there is a need for solutions offering more flexibility in the deployment and configuration of the means of verifying the authenticity and the integrity of the applications loaded on a payment terminal, while remaining compliant with the security requirements required under PCI standards in force.

### SUMMARY OF THE INVENTION

The present technique makes it possible to partly solve the problems raised by the prior art. The present technique relates indeed to a method for configuring a payment terminal, which comprises a step of loading, within a secure memory of said payment terminal, a firmware comprising a plurality of distinct cryptographic methods, each cryptographic method of said plurality being intended to allow the subsequent implementation, by a third party having the cryptographic material adapted to the considered method, of operations for verifying the authenticity and the integrity of at least one application installed on said electronic payment terminal.

In a particular embodiment, the configuration method comprises at least one step of deactivating at least one cryptographic method of said plurality of distinct cryptographic methods included in said firmware.

According to a particular feature, said step of deactivating at least one cryptographic method comprises a step of deleting or revoking a certificate associated with said at least one cryptographic method, present in said payment terminal.

In a particular embodiment, the configuration method comprises at least one step of activating at least one previously deactivated cryptographic method.

According to a particular feature, said step of activating at least one cryptographic method comprises a step of loading, within said payment terminal, a certificate associated with said at least one cryptographic method.

According to another aspect, the proposed technique also relates to an electronic payment terminal. Such a payment terminal comprises at least one secure memory in which a firmware comprising a plurality of distinct cryptographic methods, is loaded, each cryptographic method of said plurality being intended to allow the subsequent implementation, by a third party having the cryptographic material adapted to the considered method, of operations for verifying the authenticity and the integrity of at least one application installed on said electronic payment terminal.

In a particular embodiment, at least one of said distinct cryptographic methods included in the firmware of the payment terminal is deactivated.

According to a particular feature, said at least one of said deactivated cryptographic methods is reversibly deactivated.

The different embodiments mentioned hereinabove can be combined together to carry out the invention.

### FIGURES

Other features and advantages of the invention will appear more clearly upon reading the following description of a preferred embodiment of the invention, given as a simple illustrative and non-limiting example, and the appended drawings, among which:

FIG. 1 illustrates the main steps of a method for configuring a payment terminal, in a particular embodiment of the proposed technique;

FIG. 2 presents a simplified architecture of a payment terminal according to a particular embodiment of the proposed technique.

### DETAILED DESCRIPTION OF THE INVENTION

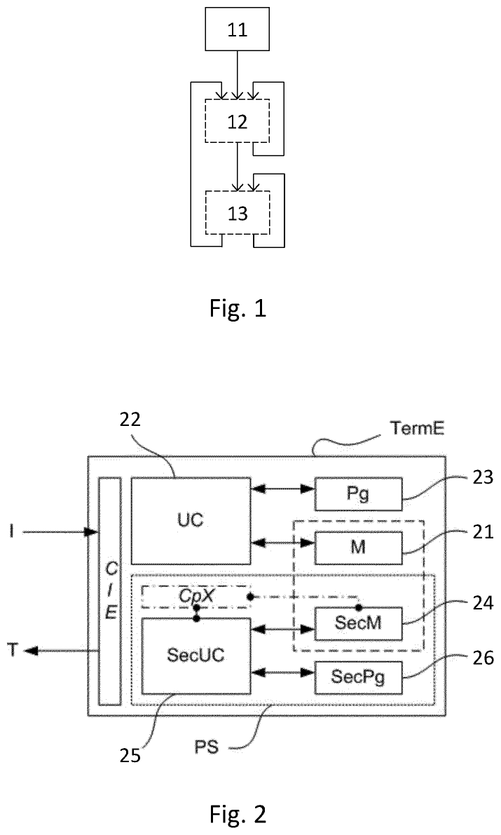

The present technique relates to a method for configuring a payment terminal, illustrated in relation to FIG. 1 in a particular embodiment. According to the general principle of the proposed technique, the method comprises a step 11 of loading, within a secure memory of the payment terminal, a firmware comprising a plurality of distinct cryptographic methods (two or more), each cryptographic method of said plurality being intended to allow the subsequent implementation, by a third party having the cryptographic material adapted to the considered method, of operations to verify the authenticity and the integrity of at least one application installed on said electronic payment terminal. The firmware integrates, for example, in the form of different sets of instructions, two distinct cryptographic methods, each allowing to perform (in a different way) operations for verifying the authenticity and the integrity of applications installed on the payment terminal. Thus, the firmware comprises for example a first cryptographic method based on an RSA cryptographic system, and a second cryptographic method based on elliptic curves. The previous example is of course given purely by way of illustration and not limitation, and the same firmware according to the proposed technique can integrate a greater number of distinct cryptographic methods. According to a particular feature, the loading step 11 is carried out in the factory, during the manufacture of the payment terminal.

Thus, unlike the solutions of the prior art, several cryptographic methods—each making it possible to verify the authenticity and the integrity of applications (and more particularly, payment applications) installed in a payment terminal—are directly implemented in the same firmware loaded into a secure memory of the payment terminal during its manufacture. In this manner, the number of firmware that the manufacturer must submit to the PCI certification processes is reduced, since it is no longer necessary to have as many firmware certified as there are methods proposed by the manufacturer. Furthermore, the manufacturing chain of payment terminals is also simplified, and manufacturing costs are reduced, since the manufacturer is no longer required to maintain as many firmware production branches as proposed methods. The integration of multiple cryptographic methods within the same firmware also offers new perspectives in terms of security since it makes it possible to carry out a series of operations to verify the authenticity and the integrity of the same application using different methods, thus offering increased guarantees in terms of securing payment terminals.

In a particular embodiment, optionally, the configuration method according to the proposed technique comprises at least one step 12 of deactivating at least one of the cryptographic methods implemented in the firmware loaded in the secure memory of the payment terminal. In the context of this technique, such a deactivation should not be understood as a deletion of the concerned cryptographic method: the relevant cryptographic method is still present in the firmware, but it can no longer be invoked thanks to the implementation of blocking means which may be software or hardware, an example of which is given by way of illustration later in this document. According to a particular feature, step 12 is implemented at least once, before introducing the payment terminal to the market, in a personalization phase of the terminal intended to make it conform to the needs and/or expectations of its purchaser. In this case, step 12 consists for example of deactivating all the cryptographic methods which do not correspond or are not compatible with the tools already deployed at the client for the implementation of operations for verifying the authenticity and the integrity of the applications installed on the payment terminal. Depending on the clients and the tools at their disposal, the cryptographic methods deactivated for the same terminal model will therefore not necessarily be the same. The proposed technique thus offers an increased flexibility in terms of personalization of payment terminals. According to another particular feature, one or more iterations of deactivation step 12 can also be implemented after the payment terminal has been introduced to market. This possibility is particularly interesting in the event that it is detected that one of the cryptographic methods implemented in the firmware presents a vulnerability that could be exploited by malicious people to obtain sensitive data and/or carry out payment transactions in a fraudulent manner: with the proposed technique, the compromised method can be deactivated and another cryptographic method present on the firmware can be used instead of the previous one. A fallback solution is thus directly and quickly available, because it is present from the beginning within the firmware of the payment terminal. To this end, in a particular embodiment, optionally, the method comprises at least one step 13 of activation (or reactivation) of a cryptographic method which would have been previously deactivated during the implementation of a deactivation step 12 as previously described. In this manner, the proposed technique makes it possible in particular to activate one of the cryptographic methods integrated from the beginning in the firmware embedded in a payment terminal, but which had typically been deactivated for the terminals acquired by a given customer, for not corresponding to the tools that were already deployed at this client. This avoids having to replace all the concerned payment terminals (whose number can reach thousands of terminals), by opting for a much less restrictive and more centralized solution consisting in deploying, if the customer does not already have them, the tools necessary to carry out operations to verify the authenticity and the integrity of payment applications according to the newly activated cryptographic method.

In one particular embodiment of the proposed technique, the activation and/or deactivation of the cryptographic methods—implemented in the firmware of the payment terminal—for verifying the authenticity and the integrity of applications is carried out by means of electronic certificates. More particularly, in this embodiment, each cryptographic method is associated with a unique electronic certificate, issued directly or indirectly (via one or several intermediate certificates) from a root certificate of the manufacturer loaded in the payment terminal, or at the very least accessible from this payment terminal (via an interface and a communication network for example). A cryptographic method can then only be used (i.e. activated) if the associated electronic certificate is also present in the payment terminal, and this certificate is valid (i.e. authentic and reliable—which can be verified by conventionally going up the chain of certificates until the root certificate—but that is also not expired and not revoked). The electronic certificate associated with a method can therefore be qualified, to a certain extent, as an activation certificate for this method. Thus, considering a payment terminal whose firmware comprises a plurality of cryptographic methods within the meaning of the proposed technique, it is the choice of the activation certificates loaded in the terminal which defines the cryptographic methods which are activated or not among said plurality of available methods.

Steps 12 and 13 previously described and relating to the activation and deactivation of cryptographic methods present in the firmware of the payment terminal then relate to operations for processing the activation certificates associated with these methods. Thus, according to a particular feature, the step 13 for activating a cryptographic method present in the firmware loaded in a payment terminal comprises the loading, within this terminal, of the activation certificate associated with said method. When it comes to step 12 of deactivating a cryptographic method present in the firmware, it can be carried out in different ways. Firstly, deactivating a cryptographic method of a payment terminal can be understood as the fact of not loading the activation certificate associated with this method in the terminal. This is typically the case of the initial configuration of the payment terminal, before its very first marketing: several cryptographic methods are present within the firmware of the terminal, but only the activation certificates associated with the methods to be activated are loaded into the terminal (which amounts to deactivating the others). Secondly, the deactivation of a cryptographic method can intervene on a previously activated method (for example because it has been detected that the relevant method, used until then, is compromised): in this case the deactivation can be implemented directly, by (temporary or permanent) deletion or revocation of the activation certificate associated with the targeted method, or even indirectly, by an action (e.g. deletion, revocation) on an intermediate certificate between the activation certificate and the root certificate aiming to break the chain normally used to verify the authenticity and the integrity of the validation certificate. Depending on the level of security sought, such operations performed on the activation certificates (loading, deletion, revocation, etc.) can be configured so that they can only be performed in the factory, with the need for a physical access to the terminal (for example only after a complete reset of the terminal, i.e. a complete reset aimed at returning it to a “factory state” prior to its personalization). Alternatively, these operations on the activation certificates can be configured in such a way as to be able to be implemented remotely, within the context of secure procedures accessible via a communication network only to authorized persons (with appropriate protective measures which can be miscellaneous: password, biometric authentication, PKI key, etc.).

According to another aspect, the proposed technique also relates to a payment terminal, a simplified architecture of which is presented in relation to FIG. 2, in a particular embodiment. Such an electronic terminal (TermE) comprises a memory 21, a processing unit 22 equipped for example with a microprocessor, and controlled by a computer program 23. The electronic terminal also comprises a secure memory 24, which can be merged with the memory 21 (as indicated in dotted lines, in this case the memory 21 is a secure memory), a secure processing unit 25 equipped for example with a secure microprocessor and physical protection measures (physical protection around the chip, for trellis, vias, etc. and protection on the data transmission interfaces), and controlled by a computer program 26 specifically dedicated to this secure processing unit 25. The secure processing unit 25 can in certain cases, depending on chosen hardware solution, be included in the processing unit 22 (it then takes the form, for example, of a dedicated secure area of the processing unit 22, isolated from the rest of the processing unit 22 so as to guarantee a perfect seal between the functionalities carried out by each part). The computer program 26 dedicated to the secure processing unit 25 can in particular take the form of a firmware comprising sets of instructions making it possible, once loaded into the secure memory 24, to define a plurality of distinct cryptographic methods, each intended to allow the subsequent implementation, by a third party having the cryptographic material adapted to the considered method and in relation to the secure processing unit 25, of operations for verifying the authenticity and the integrity of at least one application installed on said electronic payment terminal. The group made up of the secure processing unit 25, the secure memory 24 and the dedicated computer program 26 constitutes the secure portion (PS) of the electronic terminal. In at least one embodiment, this technique is implemented in the form of a firmware and a set of activation certificates installed in part or in whole on this secure portion of the payment terminal. In at least one other embodiment, the present technique is implemented in the form of a dedicated component (CpX) capable of processing data from the processing units and installed in part or in whole on the secure portion of the payment terminal. Furthermore, the terminal also comprises means of communication (CIE) for example in the form of network components (WiFi, 3G/4G/5G) which allow the terminal to receive data (1) from connected entities to one or several communication networks and transmit processed data (T) to such entities.

As explained hereinabove, in a particular embodiment, the payment terminal according to the proposed technique can be configured, in a personalization phase before its introduction to the market, or after its introduction to the market, in such a way that at least one of the plurality of cryptographic methods embedded in firmware 26 is deactivated. According to one particular feature of this embodiment, such a deactivation is reversible, and a previously deactivated cryptographic method can be reactivated (so as, for example, to act as an integrated fallback position, in the event that a security vulnerability is detected on a previously used cryptographic method).

1. A method for configuring a payment terminal, the method being wherein it comprises:
a step of loading, within a secure memory of the payment terminal, a firmware comprising a plurality of distinct cryptographic methods, each cryptographic method of the plurality being intended to allow the subsequent implementation, by a third party having cryptographic material suitable for the considered method, of operations for verifying the authenticity and the integrity of at least one application installed on the payment terminal;
at least one step of deactivating at least one cryptographic method of the plurality of distinct cryptographic methods included in the firmware, the deactivation step comprising a step of deleting or revoking a certificate associated with the at least one cryptographic method, present in the payment terminal.

2. The configuration method according to claim 1, wherein it comprises at least one step of activating at least one of the previously deactivated cryptographic methods.

3. The configuration method according to claim 2, wherein the step of activating at least one cryptographic method comprises a step of loading, within the payment terminal, a certificate associated with the at least one cryptographic method.

4. A payment terminal wherein it comprises:
at least one secure memory in which is loaded a firmware comprising a plurality of distinct cryptographic methods, each cryptographic method of the plurality being intended to allow the subsequent implementation, by a third party having the cryptographic material adapted to the considered method, of verification operations of the authenticity and integrity of at least one application installed on the payment terminal;
means for deactivating at least one cryptographic method of the plurality of distinct cryptographic methods included in the firmware, the said-deactivation means comprising means for deleting or revoking a certificate associated with the at least one cryptographic method, present in the payment terminal.

5. The payment terminal according to claim 4 wherein at least one of the distinct cryptographic methods is deactivated.

6. The payment terminal according to claim 5 wherein at least one of the deactivated cryptographic methods is reversibly deactivated.
